(19) United States
(12) Patent Application Publication
(10) Pub. No.: US 2022/0414604 A1
(43) Pub. Date: Dec. 29, 2022

(54) SYSTEM AND METHOD FOR PROVIDING ENHANCED PLATFORM AND VIDEO SUPPLEMENT FOR RESUMÉ REVIEW

(71) Applicant: Brant Bleacher, Tampa, FL (US)

(72) Inventor: Brant Bleacher, Tampa, FL (US)

(21) Appl. No.: 17/358,843

(22) Filed: Jun. 25, 2021

(51) Int. Cl. G06Q 10/10; G06F 9/451; G06F 3/0485

(52) U.S. Cl. CPC G06Q 10/1053; G06F 9/451; G06F 3/0485; G06F 2203/04803

(57) ABSTRACT

A system and method related to filling employment positions that provides for supplementing and enhancing resume review to provide employers and prospective employees an efficient platform for open position and candidate review utilizing a video supplement to traditional resume that provides a scroll bar tracker. This system and method facilitates an intermediate step between traditional resume submission and review and virtual or in-person interview to provide both employers and job candidates with a more efficient use of time by providing a quick and easy higher level candidate and position review step before committing to the more time intensive in-depth interview.

### FIELD OF THE INVENTION

A system and method related to filling employment positions that provides for supplementing and enhancing resume review to provide employers and prospective employees an efficient platform for open position and candidate review utilizing a video supplement to traditional resume that provides a scroll bar tracker. This system and method facilitates an intermediate step between traditional resume submission and review and virtual or in-person interview to provide both employers and job candidates with a more efficient use of time by providing a quick and easy higher level candidate and position review step before committing to the more time intensive in-depth interview.

### BACKGROUND

Traditionally, job seekers apply for open positions by submitting a paper resumé (which could also be saved in electronic format and emailed or submitted online, but nevertheless needs to be physically read) that outlines that candidate's qualifications and accomplishments. The employer, upon receipt of a plethora of resumés, reviews them and ranks them in terms of perceived qualifications of the candidates that are more important to that employer. The employer then reaches out to the higher ranked candidates to conduct an interview to more thoroughly vet the chosen candidates. The full process, from posting a job opening to actually hiring a candidate can take many weeks.

There have been attempts to streamline the hiring process and also make it more effective and accurate in more quickly identifying suitable candidates. The traditional process described above may miss otherwise great candidates if the paper resumé does not portray the candidate in a great light or otherwise fail to highlight or mention some characteristics especially important to the employer. The traditional process described above may also include for interviews candidates that are not particularly suited for a position because the resumé suggests characteristics important to the employer not actually strong suits of the candidate.

One method of making the hiring process more efficient has been to use computer technology to implement most of the steps of the traditional hiring process. For example, in U.S. Pat. No. 8,959,035 to LifeWorx, Inc., entitled, SYSTEM AND METHOD FOR SCREENING AND PROCESSING APPLICANTS, disclosed is, “systems and methods for performing efficient job applicant screening. In particular, a network-based system is established for gathering applicant information from an applicant remotely. Analysis of the received information is performed and evaluated pursuant to a first level of screening that can be done without excessive use of resources. Upon passing the first level screening, background checks and/or interviews, which require substantial resources, are further conducted. Applicants who pass the first level of screening are scheduled for interviews, including the optional initiation of personal interviews via video chat.” However, in this system and method, nothing particularly new is added to or modified in the traditional format other than using computers and artificial intelligence to automate certain tasks. There is still a traditional gathering of information about the candidate (the resumé) leading to some candidates being chosen for a personal interview, albeit via video chat. The success of the process, like in the traditional manner described above being dependent upon the skill of the hiring people reviewing the candidates, is similarly dependent upon the skill of the automation.

The use of video chat is also well established in the prior art. For example, in U.S. Pat. No. 9,135,605 to Adobe Systems Incorporated, entitled, INSTANT ELECTRONIC MEETING FROM WITHIN A CURRENT COMPUTER APPLICATION, disclosed is, “real time communication is discussed that may be initiated and maintained from within an web-based application without leaving the context of the underlying application. Within the web-based application, a web frame or portlet is displayed that can maintain a separate and independent communication channel with a data resource and other external resources. When activated by a user of the web application, the web frame or portlet establishes a communication link with an external resource and another party that will take part in a communication exchange. The interaction between the user and the other participant are displayed from within and/or processed by the web frame or portlet without affecting the state of the underlying web application.” Thus, not only can video interviews be conducted virtually, here, it is disclosed that they can be conducted within the confines of some other computer based system without the need for leaving that system. Still, though, success of the hiring process depends upon the skill of the hiring people and/or the automated system in identifying the right candidates to interview.

Other technical aspects of the traditional process have also garnered attention through the use of computer automation. See for example, U.S. Pat No. 6,272,467, to Spark Network Services, Inc., entitled SYSTEM FOR DATA COLLECTION AND MATCHING COMPATIBLE PROFILES (relating to “an automated method for identifying matches between a set of predetermined traits and a set of preferences”); U.S. Pat. No. 7,945,846 to Oracle International Corporation, entitled APPLICATION-SPECIFIC PERSONALIZATION FOR DATA DISPLAY (relating to “a method of optimizing a set of elements on a device display”); U.S. Pat No. 8,422,981, to Oracle Taleo LLC, entitled, RESUME STORAGE AND RETRIEVAL SYSTEM (relating to “a method of and apparatus for storage and retrieval of resumé images”); US Patent Application Publication No. US 2006/0059147, to Yahoo! Inc., entitled SYSTEM AND METHOD OF ADAPTIVE PERSONALIZATION OF SEARCH RESULTS FOR ONLINE DATING SERVICES (relating to “a system and method directed towards automatically modifying online dating service's search results based on adaptive personalization from a user's activities”); US Patent Application Publication No. US 2008/0262859, to Yahoo! Inc., entitled SYSTEMS AND METHODS FOR PROVIDING A VIDEO RESUME (relating to “methods and systems for providing a video resumé”); and US Patent Application Publication No. US 2020/0259884, to Bluepipes, Inc., entitled AN ONLINE PLATFORM AND A METHOD FOR FACILITATING SHARING OF DATA BETWEEN USERS (relating to, “an online platform for facilitating sharing of data between users.”).

All of the foregoing prior art and in fact, all known prior art directed to bettering the hiring process, all relate to refining or automating a traditional step in the process. None of the foregoing references, alone or in combination, add any materially new step that would serve to make the hiring process more efficient and more effective.

In some embodiments, this disclosure teaches enhancing providing a standard written resumé, with instructions for the candidate submitting such resumé, to provide a video resumé enhancement, that when viewed by an employer or other hiring decision maker, is provided a side-by-side screen where on the one side is the standard written resumé and on the other side is the video enhancement. In some embodiments, the video enhancement is not merely a rehash of the resumé or a reading verbatim of the resumé. In fact, that is one thing expressly that it is not. In some embodiments, the video enhancement provides more detail and context to the written resumé, providing depth not otherwise capable of fitting into a traditional resumé.

In some embodiments, the written resumé and the video enhancement and the screens they are presented on are linked with a scrolling tracker, such that the written resumé is highlighted to correspond to the place in the video enhancement that relates to the part of the resumé being enhanced.

The foregoing embodiments provide the employer or other hiring decision maker with important context and deeper information than a mere written or even a typical video resumé can provide, but in the same time frame that the resumé would ordinarily take to be reviewed. In this manner, live interviews can be chosen with greater accuracy, eliminating the need for some, providing desire to have some where none might have otherwise existed, and efficiently and effectively streamlining the overall process.

None of the prior art references, alone or in combination, teach providing a resumé video enhancement that is provided along with the traditional format resumé where the two components are tied together with a scrolling link on juxtaposed screens.

The present disclosure teaches several embodiments of a system and method for enhancing the employment hiring process by arming employers, hiring decision makers, recruiters, and the like, with an enhanced resumé tool to provide greater depth and context than can be delivered in a typical resumé, whether written or video format. This provides for more skilled decisions in moving forward with interviews.

### SUMMARY

The present disclosure teaches embodiments of a system and method for enhancing the hiring process whereby a job applicant, when submitting a resumé through the system, is directed by the system to provide a video enhancement for said resumé, and wherein said system provides a scrolling bar link and resumé highlighting to provide the recipient of the resumé application with a two part screen, one part having the written and highlighted traditional resumé and the second part containing the video enhancement and the two parts joined by a scrolling link enabling the viewer to jump to any part of the resumé and corresponding video enhancement at any point.

The hiring process will always involve an employer desiring an employee with particular capabilities and embarking on a search for such candidate. This will always involve posting in some manner that a position is open and inviting responses from potential candidates. The process will then necessarily entail receiving an indication from potential candidates of an interest, usually in the form of an application and/or resumé. Then, the employer or other hiring decision maker must review the applications/resumés and make initial decisions of interest and then narrow the initial pool into potential offers. Embodiments of the tools described here provide enhanced ability to more efficiently and effectively initially review the applications/resumés and request additional information.

In one embodiment, the initial application/resumé will be received by the employer/hiring decision maker with a video enhancement providing more detailed insight into the potential candidate and provide it in the same amount of time as it would have taken the employer/hiring decision maker to review the material without the video enhancement. In one embodiment, the employer/hiring decision maker may move back and forth throughout the resumé, beginning, middle, or end, and have the video enhancement follow along exactly and provide highlighting in the resumé so the reviewer will never lose their place.

In one embodiment, the reviewer will be provided with additional tools to mark their review, rank potential candidates, ask for more information or follow up on certain aspects, or dismiss.

### BRIEF DESCRIPTION OF THE DRAWINGS

FIG. 1 depicts one embodiment of a flowchart of an arrangement of the various component persons/entities in the hiring process, comprising at least, (A) an employer, (B) a job opening listing, (C) a prospective employee candidate, and (D) a server configured with functionality for providing a resumé video enhancement, all connected via some connecting server Internet or intranet, which could be wired, wireless and/or cloud based.

FIG. 2 depicts one embodiment of a layout for a resumé video enhancement as might be viewed by an employer/hiring decision maker.

FIG. 3 depicts one embodiment of a layout for a screen for responses by a prospective candidate to an employer/hiring decision maker after having viewed the original resumé and video enhancement and wanting more information.

### DETAILED DESCRIPTION

For clarity of disclosure, and not by way of limitation, the detailed description of the invention is divided into the following subsections that describe or illustrate certain features, embodiments or applications of the present invention.

### Definitions

“video enhancement” as used herein means a recorded video file with sound wherein a potential job candidate is directed to record themselves providing more detailed information about aspects of their resume and their capabilities and qualifications for a particular job opening to which they are applying. During the creation of the ‘video enhancement’, the system is configured to record what portion of the resumé is applicable to a particular portion of the video recording such that during playback, the resumé is highlighted so that a reviewer may easily see to what portion of the resumé, the particular portion of the video corresponds.

“scrolling link” as used herein means a clickable virtual slider configured to allow a reviewer of a resumé and video enhancement to move through either at will and have the corresponding area of the other component follow along. Thus, a reviewer wanting to move to a specific spot in a resumé may click and scroll the slider to the exact spot they want, and the corresponding portion of the video enhancement will be queued for play. The scrolling link connects the resumé and video enhancement and allows them to be simultaneously scrolled.

“resumé” as used herein means and assemblage of information about a potential job candidate created for use by a potential job candidate to provide to employers with a job opening to alert the employer or the employer's hiring decision maker about the potential job candidate's qualifications for such opening.

### The System and Method of the Present Invention

This disclosure describes embodiments of a system and method for providing tools to an employer or the employer's hiring decision maker, or anyone with influence in that decision, for making the hiring decision more efficient and effective.

Most, if not all, hiring decisions necessarily involve the extensive review of applications and resumés of many individuals applying for a job opening. Such review entails knowing the qualifications and capabilities an ideal candidate would possess for any particular opening, then reviewing resumés to identify individuals claiming to possess the most of all of those qualifications and capabilities and then deciding among those identified as most qualified, who would be the best fit based on verification of possession of those qualifications.

In some situations, the initial weeding out of candidates can be done automatically, and in fact, the prior art describes using artificial intelligence and other machine algorithms to weed out unqualified candidates. For example, if the open position requires a certain degree, or a certain amount of experience, it is a simple matter to determine if there is an indication of possessing such degree or experience. If a nursing degree or ten years nursing experience in an emergency room setting is a requirement, this is easy to determine as well as verify.

However, not all job qualifications are so black and white. Many are nuanced. Sometimes, success in various employment positions, although very different, can indicate a likelihood of success in some other also very different position where a particular expertise is not required. Making hiring decisions is therefore not always an exact science and any tools or additional insights that can be provided to the job candidate reviewer can be quite valuable. Not every qualification translates nicely to a written resumé. On the other hand, some written resumés can appear quite impressive while the candidate themselves may not be quite what it appears.

While video resumés can be an effective tool and exist in the prior art, they can be cumbersome and time consuming to view. Moreover, video resumés do not lend themselves to easy and efficient re-review. It is effective, therefore, to have a written resumé that is easy to view ‘at-a-glance’. It is more effective to have that ‘at-a-glance’ written resumé enhanced with some of the benefits of the video resumé stripped of the inconveniences and time-consuming nature of having to view and sift through unwanted parts of the video resumé.

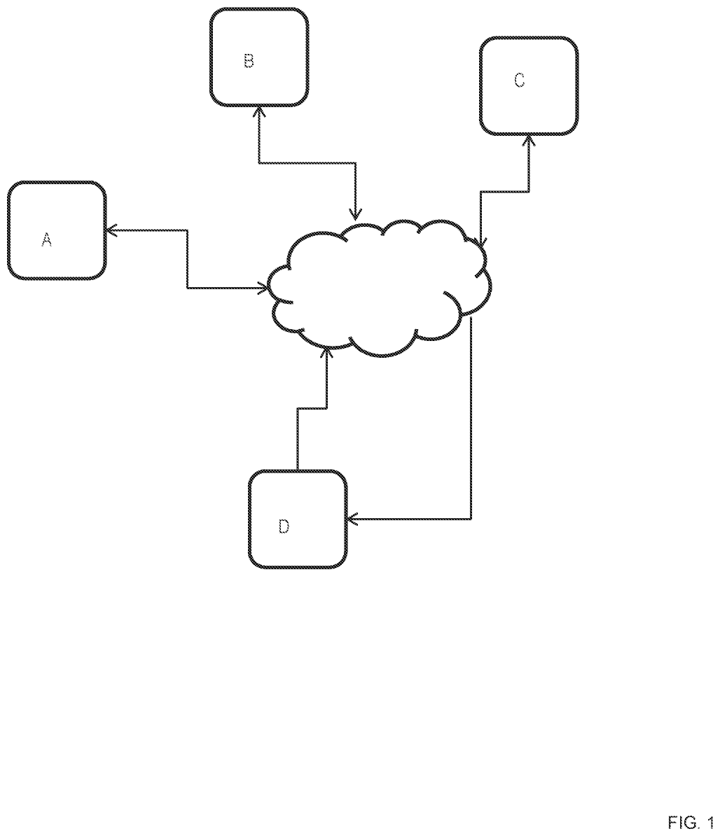

Referring to FIG. 1, in some embodiments, an employer (A), a job posting site (B), and a potential job opening candidate (C) are all connected through the cloud (or Internet, or other intranet computer based connectivity). In some embodiments, the job posting site (B) is configured with software implementing a resumé video enhancement (D) as more fully described elsewhere herein. When the employer (A) has a job opening and desires to advertise for suitable candidates and receive applications and resumés from those candidates, they will advertise the job opening on some site (B). The job posting site (B) could be the employer's own internal job posting webpage, or a third-party website such as LinkedIn® or Indeed®, or with a professional recruiter. Once the job opening is posted, a potential job candidate (C) will view the posting and have an interest in the position and transmit back to the job posting site (B) of their interest. The job posting site (B) will instruct the job candidate (C) to upload their resumé and provide whatever other application materials required by the employer (A) and, if enabled with technology as described herein, further then implement the video enhancement instructions to generate the video enhancement which will all then be transmitted back to the employer (A) and/or the job posting site (B), i.e., the candidate placement decision maker.

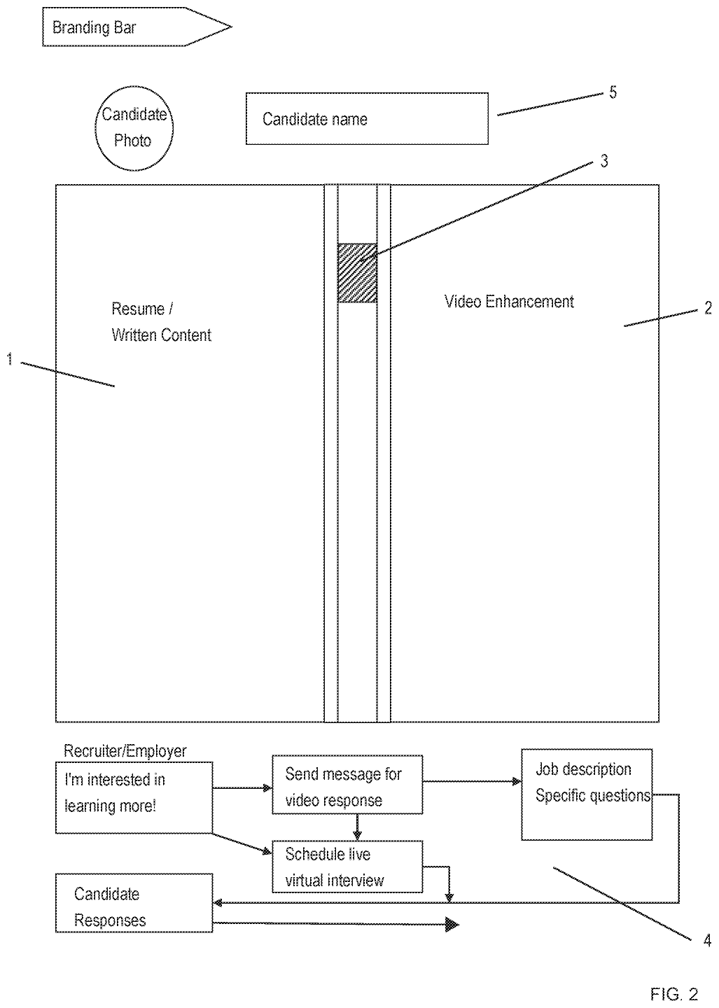

Referring to FIG. 2, embodiments of a video enhancement creation technology are described. For example, a job candidate may be instructed to upload their current written resumé (1) and when that is done, the job candidate may be provided instructions to create a video enhancement to augment and supplement the written resumé. In some embodiments, once the video enhancement (2) is recorded and created pursuant to instructions provided to the potential job candidate, the software configured to implement the video enhancement is further configured to, during the video enhancement creation process, link certain portions of the video enhancement (2) to the corresponding portions of the written resumé (1), and provide highlighting of that portion of the written resumé when the corresponding portion of the video enhancement plays and further to provide a scrolling link (3) to allow a reviewer to instantly scroll to any portion of either the written resumé or the video enhancement and also be then directed to the corresponding part of the other component.

Continuing with FIG. 2, in some embodiments, when a reviewer is reviewing a resumé and a video enhancement, they could also be presented with additional tools (4), such as links to requesting additional information, sending the job candidate a message for a video response or to answer additional specific questions, and to actually schedule a live (or virtually live) interview. In some embodiments, the potential job candidate's identity is shown in a header on the page (5) and in this way, the reviewer knows which candidate they are reviewing and can also compare the name and likeness with the person appearing in the video enhancement to ensure they are one and the same.

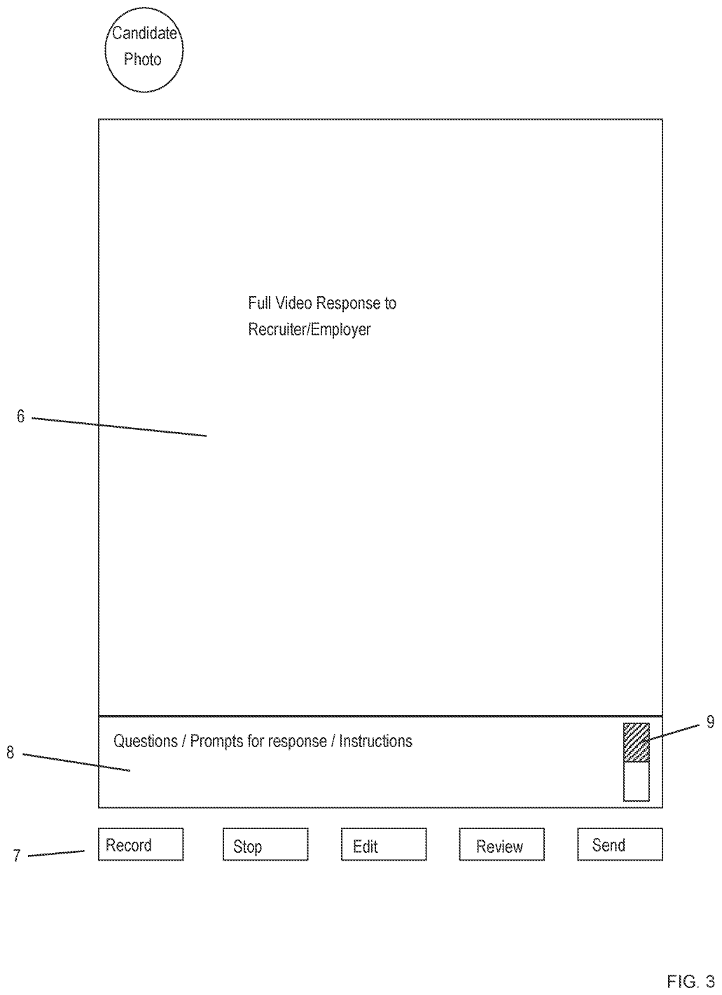

Referring to FIG. 3, in some embodiments, the potential job candidate who has submitted a resumé through the system as described herein and has been presented with a request for follow-up, may provide a video response (6) to answer specific questions or requests for specific additional information (8) from the employer. In some embodiments, when the employer or candidate reviewer has more than one request for additional information, the screen area where these requests are viewed may be enabled with a scroll button (9) to move between the various requests. In some embodiments, the potential job candidate may control the functionality of the video response through typical control links (7), such as to record, stop, edit, review, etc.

### EXAMPLES

The present invention is further illustrated, but not limited by, the following examples.

A typical use of the technology as described herein is in the context of a job posting (but one skilled in the art may discern other uses and this disclosure should not be limited in any way by this example).

In some embodiments, an employer with a desire to employ someone with certain skills or qualifications posts an ad to induce potential job candidates to apply for the open position. Such an application typically includes requesting a resumé that outlines the candidate's qualifications and prior work accomplishments and experience. Typically, job candidates are versed in creating a resumé that is concise, so that a reviewer can quickly and easily identify qualified candidates while highlighting their most desirable qualities. Resumés are inherently limited by their brevity.

Some employers or job candidate reviewers, such as recruiters, like additional or more detailed information and request a video resumé so that they can see and hear the candidate or request virtual interviews for the same reason and to be able to ask specific questions that may come up. The problem with this is the brevity is replaced with something much more time consuming. Instead, by implementing embodiments of the video enhancement as described above, the job candidate reviewer gets the brevity of the written resumé and the benefits of the video, i.e., being able to hear and see a candidate, without the need to view an entire video resumé or conduct a virtual interview. The job candidate reviewer is enabled with technology that allows them to review only the parts of the video corresponding to the part of the written resumé that is important to them in a given situation. If the reviewer sees or hears anything that they want more information about, they can instantly review the part of the written resumé that corresponds. Alternatively, if they see something on the written resumé that they want more information about, they can instantly scroll to the area of the video enhancement that may provide further insight, including the ability to hear and see the candidate describe in more detail that part of their resumé. If that is not enough, the reviewer can then request follow-up information, set that candidate application aside while reviewing others, and come back to the exact spot left off when the applicant responds. In this manner, the reviewer can schedule in-person or virtual live interviews with only the very few most qualified candidates and save a lot of time and energy.

Publications cited throughout this document are hereby incorporated by reference in their entirety. Although the various aspects of the invention have been illustrated above by reference to examples and preferred embodiments, it will be appreciated that the scope of the invention is defined not by the foregoing description but by the following claims properly construed under principles of patent law.

Each and every feature described herein, and each and every combination of two or more of such features, is included within the scope of the present invention provided that the features included in such a combination are not mutually exclusive.

What is claimed is:

1. A system for enhancing the employment hiring process comprising:
accessing a website configured to direct prospective job applicant to transmit a resumé in response to a job posting applicant request; and
upon said prospective job applicant transmitting a resumé, directing said prospective job applicant to record themselves providing more detailed information about aspects of their resumé and their capabilities and qualifications creating a video enhancement for said resumé; and
upon completion of said prospective job applicant transmitting said resumé and completing said video enhancement corresponding to said resumé, configuring said resumé and said corresponding video enhancement to be linked with a scrolling link virtual sliding joinder wherein said resumé is configured with highlights corresponding to the place within the video enhancement timeline that is relevant to said place in said resumé; and
delivering to the requester of said job posting applicant request, a dual screen format wherein a first part of said dual screen is configured to display the resumé and a second part of said dual screen is configured to display the video enhancement, and wherein said first and second parts of said dual screen are displayed juxtaposed to each other and linked with a scrolling link virtual sliding joinder wherein said scrolling link is configured to provide the requester the ability to scroll through either the resumé or the video enhancement and have displayed on the corresponding part of said dual screen the corresponding part of the other component.

2. The system of claim 1, wherein said first part of said dual screen configured to display the resumé, is further configured to display said highlight of the resumé that corresponds with the part of the video enhancement being displayed at any given moment.

3. The system of claim 1, further configured to provide the requester of said job posting applicant request the ability to request further information from any applicant.

4. The system of claim 1, further configured to provide any applicant of whom further information is requested, the ability to respond in the manner requested.

5. A method of hiring a job applicant wherein the system for enhancing the employment hiring process of claim 1 is implemented by a requester posting a job applicant request such that first, the requester posts a job applicant request, then a job candidate replies to the job applicant request by transmitting a resuméand any other requested materials, and then is directed to follow instructions to create a video enhancement, and wherein said resumé, additional materials and video enhancement are then linked with a scrolling link virtual sliding joinder and delivered to the requester for review and then said requester reviews said resumé and video enhancement using said scrolling link and upon finding a desirable candidate, requesting an interview or offering the position to said candidate.
